(19) United States
(12) Patent Application Publication
(10) Pub. No.: US 2009/0002490 A1
(43) Pub. Date: Jan. 1, 2009

(54) ACOUSTIC RECOGNITION APPARATUS, ACOUSTIC RECOGNITION METHOD, AND ACOUSTIC RECOGNITION PROGRAM

(75) Inventor: Mutsumi Saito, Fukuoka (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/147,693

(22) Filed: Jun. 27, 2008

(30) Foreign Application Priority Data
Jun. 27, 2007 (JP) 2007-169117

(51) Int. Cl. H04N 7/18

(52) U.S. Cl. 348/143; 348/E07.085

(57) ABSTRACT

An acoustic recognition apparatus determines whether or not a pre-stored target acoustic signal of a target sound subject to detection is contained in an entered input acoustic signal. The acoustic recognition apparatus includes an acoustic signal analysis part, a target sound storage part, a characteristic frequency extraction part, a calculation part, and a determination part.

### CROSS-REFERENCE TO RELATED APPLICATIONS

This application is related to and claims priority under 35 U.S.C §119(a) on Japanese Patent Application No. 2007-169117 filed on Jun. 27, 2007, and is incorporated by reference herein.

### BACKGROUND OF THE INVENTION

1. Technical Field

The present invention relates to an acoustic recognition apparatus for recognizing a specific acoustic signal and in particular, to an acoustic recognition apparatus, an acoustic recognition method, and an acoustic recognition program for recognizing an acoustic signal using an intensity distribution of a frequency.

2. Description of the Related Art

A monitoring camera has previously been used as a device for confirming the state of a specific place or thing. The monitoring camera is effective in detecting an abnormality such as an intrusion by a criminal. However, a simple image monitoring system requires a person in charge of monitoring to continuously watch a monitor at all times. Therefore, the person can fail to detect an abnormality, particularly in the event of an increase in workload of the person in charge of monitoring. With that in mind, in recent years, a device has been provided using image recognition technology able to detect and report both a motion of a person and a state of a thing. The device is used in applications where someone moves around in a place where persons should not have entered, or applications such as finding a defective product in a product line of a factory. Unfortunately, the range which can be provided by such image monitoring is limited to within the angular field of view of a camera. In addition, an abnormality may not be found simply by watching. Consequently, the image recognition alone is not perfect, and some other complementary methods are required.

In view of this, a method to detect an abnormality by detecting a specific sound using an acoustic recognition technology has been considered. For example, Japanese Patent Laid-Open No. 2005-196539 discusses an apparatus which detects a shutter sound in order to prevent unauthorized filming (e.g., sneak shot and digital shoplifting). The apparatus includes at least one sound collecting microphone that is responsive to the sound of photography in a prohibited area. When a visitor takes a picture in the photography prohibited area, the sound collecting microphones collect the sound. The apparatus compares the collected sound with at least one shutter sound sample data stored in a database to identify whether or not the sound is a shutter sound. If the collected sound is a shutter sound, the apparatus issues a warning sound.

Japanese Patent Laid-Open No. 10-97288 discusses a technique which analyzes an input sound signal to obtain a spectrum feature parameter, and recognizes the sound type based on the spectrum feature parameter. The apparatus is provided with a power ratio calculation part and a ratio information/time constant conversion part. The power ratio calculation part obtains the ratio information between the power of the spectrum feature parameter and the power of the estimated noise spectrum. The ratio information/time constant conversion part outputs a time constant of an estimated update of the estimated noise spectrum according to the ratio information. Further, the apparatus is provided with a noise spectrum forming part and a noise removing part. The noise spectrum forming part forms a new estimated noise spectrum based on the time constant, the spectrum feature parameter, and the previous estimated noise spectrum. The noise removing part removes a noise component by subtracting the noise spectrum from the spectrum feature parameter. Still further, the apparatus includes a pattern recognition part. The pattern recognition part determines the sound type by matching a reference parameter pattern with the spectrum feature parameter whose noise component is removed.

### SUMMARY

According to an aspect of an embodiment, an acoustic recognition apparatus determines whether or not a pre-stored target acoustic signal of a target sound subject to detection is contained in an entered input acoustic signal. The acoustic recognition apparatus includes an acoustic signal analysis part which divides the input acoustic signal into a plurality of frames separated by a unit time including at least one cycle of the target acoustic signal, obtains a frequency spectrum of the frames analyzed for each frequency, and creates an input frequency intensity distribution composed of the plurality of frames based on the frequency spectrum. A target sound storage part divides the target acoustic signal into a plurality of frames, analyzes the plurality of frames for each characteristic frequency having a feature of the target acoustic signal, and stores said frames including characteristic frequency having a feature of the target acoustic signal as a target frequency intensity distribution. A characteristic frequency extraction part extracts only a component of a characteristic frequency of the target acoustic signal stored by the target sound storage part from the input frequency intensity distribution created by the acoustic signal analysis part, and creates a characteristic frequency intensity distribution. A calculation part continuously compares the target frequency intensity distribution stored by the target sound storage part with the characteristic frequency intensity distribution created by the characteristic frequency extraction part by shifting the frames, and calculates a difference between the target frequency intensity distribution and the characteristic frequency intensity distribution. A determination part determines whether or not the target acoustic signal is contained in the input acoustic signal based on the difference calculated by the calculation part.

### BRIEF DESCRIPTION OF THE DRAWINGS

FIG. 1 is a schematic block diagram of a hardware configuration in which an acoustic recognition apparatus in accordance with the first embodiment is implemented as a dedicated board;

FIG. 2 is a block diagram of a module configuration of the acoustic recognition apparatus in accordance with the first embodiment;

FIG. 3 is an operation chart showing the operation of the acoustic recognition apparatus in accordance with the first embodiment;

FIGS. 4A, 4B and 4C show a process of creating an input frequency intensity distribution;

FIGS. 5A, 5B and 5C show a process of creating an input frequency intensity distribution (non-target sound is included);

FIGS. 6A and 6B show a method of detecting a presence or absence of a target sound from an input sound;

FIG. 7 shows a process of comparing a characteristic frequency intensity distribution and a target frequency intensity distribution (only the target sound is included);

FIG. 8 shows a process of comparing the characteristic frequency intensity distribution and the target frequency intensity distribution (one frame before);

FIG. 9 shows a process of comparing the characteristic frequency intensity distribution and the target frequency intensity distribution (one frame after);

FIGS. 10A, 10B and 10C show a process of calculating the difference between the characteristic frequency intensity distribution and the target frequency intensity distribution;

FIGS. 11A and 11B show a result of continuously plotting total values calculated by calculation part;

FIG. 12 shows a frequency spectrum focusing on a frame containing a target sound;

FIG. 13 is a block diagram of a module configuration of an acoustic recognition apparatus in accordance with a second embodiment;

FIG. 14 is an operation chart showing the operation of the acoustic recognition apparatus in accordance with the second embodiment;

FIGS. 15A and 15B show a process of dividing an input sound into predetermined frequency bands;

FIG. 16 is a block diagram of a module configuration of an acoustic recognition apparatus in accordance with a third embodiment;

FIG. 17 is an operation chart showing the operation of the acoustic recognition apparatus in accordance with the third embodiment;

FIGS. 18A, 18B and 18C show a detection method for a case where a differentiation process is performed on a result calculated by the calculation part;

FIG. 19 is a block diagram of a module configuration of an acoustic recognition apparatus in accordance with a fourth embodiment;

FIG. 20 is an operation chart showing the operation of the acoustic recognition apparatus in accordance with the fourth embodiment;

FIG. 21 shows a process of determining a local peak;

FIGS. 22A and 22B show a process of selecting a peak which can be regarded as a characteristic frequency from the local peaks;

FIG. 23 shows an example of information stored in a target sound storage part;

FIG. 24 is a block diagram of a module configuration of an acoustic recognition apparatus in accordance with a fifth embodiment;

FIG. 25 is an operation chart showing the operation of the acoustic recognition apparatus in accordance with the fifth embodiment; and

FIG. 26 is a schematic block diagram of a hardware configuration in which an acoustic recognition apparatus in accordance with other embodiments is implemented as a personal computer.

### DETAILED DESCRIPTION OF THE EMBODIMENTS

Hereinafter, embodiments will be described. The embodiments can be implemented in many different forms. Therefore, the embodiments should not be restrictively interpreted by the description of the present embodiments. It should be noted that the same reference numeral denotes the same element throughout the present embodiments.

The description of the present embodiments focuses on an apparatus, but as it should be apparent for so called those skilled in the art, that the present embodiments can also be implemented as a system, a method, and a program causing a computer to operate. In addition, the present embodiments can be implemented as hardware, software, or an embodiment of hardware and software. The program can be recorded in any computer-readable medium such as a hard disk, a CD-ROM, a DVD-ROM, an optical storage device and a magnetic storage device. Further, the program can be recorded in another computer via a network.

### First Embodiment

### (1. Configuration)

### (1-1 Hardware Configuration of the Acoustic Recognition Apparatus)

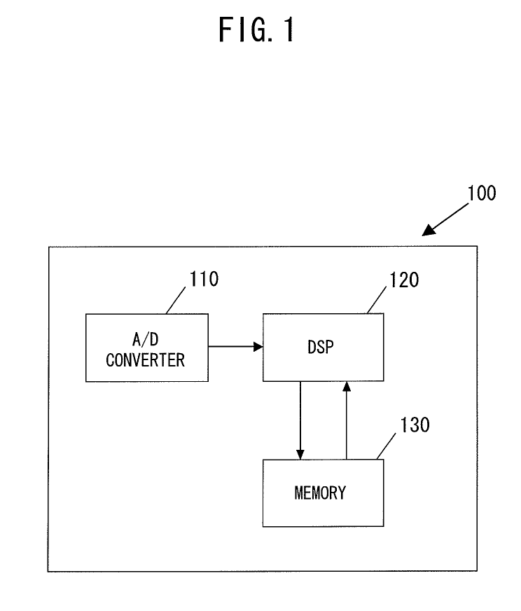

FIG. 1 is a schematic block diagram of the hardware configuration in which an acoustic recognition apparatus 100 in accordance with a first embodiment is implemented as a dedicated board.

The acoustic recognition apparatus 100 in accordance with the first embodiment is provided with an A/D converter 110, a DSP 120 (Digital Signal Processor), and a memory 130.

The A/D converter 110 performs processes of reading an analog input signal entered from a microphone and converting the signal into a digital signal.

The DSP 120 in which the converted digital signal is entered performs an acoustic recognition process according to an acoustic recognition program.

It should be noted that the acoustic recognition apparatus 100 can also include a device to display the execution result on a screen or make a sound from a speaker as a warning sound for a user to confirm.

The memory 130 performs processes of storing the acoustic recognition program as well as storing a feature of a target sound.

### (1-2 Module Configuration of the Acoustic Recognition Apparatus)

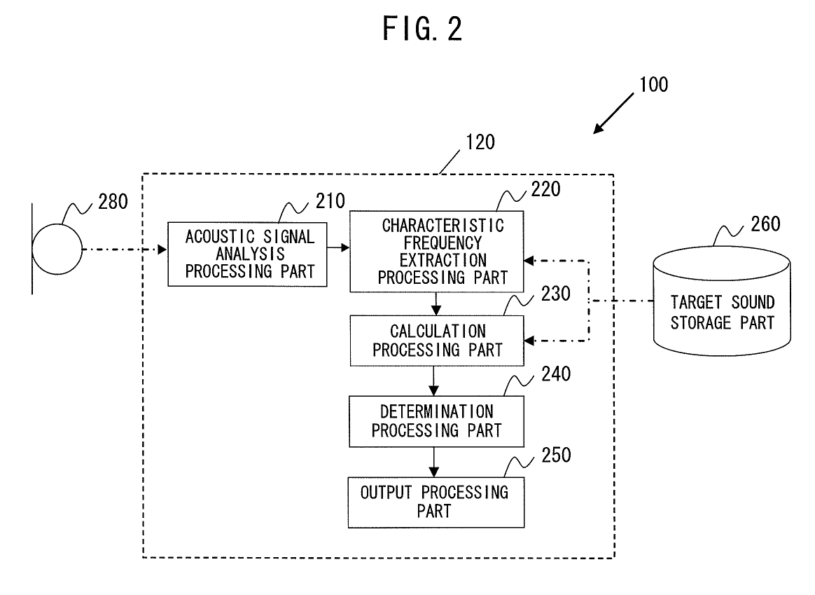

FIG. 2 is a block diagram of a module configuration of the acoustic recognition apparatus in accordance with the first embodiment.

The acoustic recognition apparatus 100 includes an acoustic signal analysis processing part 210, a characteristic frequency extraction processing part 220, a calculation processing part 230, a determination processing part 240, an output processing part 250, and a target sound storage part 260.

The acoustic signal analysis processing part 210 divides an acoustic signal entered from a microphone 280 into frames separated by a predetermined unit time (e.g., 20 msec). Further, the acoustic signal analysis processing part 210 performs a frequency analysis for each divided frame to obtain a frequency spectrum. The acoustic recognition apparatus 100 can obtain an intensity distribution of a frequency by storing the spectrum data for a plurality of frames. In other words, the acoustic recognition apparatus 100 performs a process of creating an input frequency intensity distribution showing an intensity of an input sound composed of a plurality of frames based on the obtained frequency spectrum.

It should be noted that a user can set any time length of one frame, but it is desirable that the time length of one frame should contain at least one cycle of a target sound subject to detection. Doing so allows the acoustic recognition apparatus 100 to detect a target sound is contained in the input sound with high accuracy. The user can also set any number of frames, but preferably about 50 to 100 frames (one second to two seconds in the case where one frame is 20 msec) should be set to the time length, which allows the acoustic recognition apparatus 100 to detect with a high accuracy.

The target sound storage part 260 stores information about the target sound subject to detection. More specifically, for example, a characteristic frequency indicating a feature of the target sound, a magnitude of a component of the characteristic frequency and other information are stored as a target frequency intensity distribution for each frame.

The characteristic frequency extraction processing part 220 performs a process of creating a characteristic frequency intensity distribution by extracting only the characteristic frequency component of the target sound stored by the target sound storage part 260 from the input frequency intensity distribution created by the acoustic signal analysis processing part 210. In so doing, the component of a frequency region not related to the target sound subject to detection is deleted from the input frequency intensity distribution.

It should be noted that when the characteristic frequency extraction processing part 220 extracts the characteristic frequency component of the target sound, the characteristic frequency extraction processing part 220 may extract only the value of the frequency. However, when the characteristic frequency extraction processing part 220 extracts the characteristic frequency component of the target sound, preferably the characteristic frequency extraction processing part 220 extracts should extract by allowing for from 50% to 200% of the characteristic frequency at the maximum. In doing so, a small error may occur, but the component of the characteristic frequency can be surely extracted.

The calculation processing part 230 performs a process of calculating the difference between the target frequency intensity distribution stored by the target sound storage part 260 and the characteristic frequency intensity distribution created by the characteristic frequency extraction processing part 220. More specifically, the difference is calculated by subtracting the characteristic frequency intensity distribution from the target frequency intensity distribution. The process is continuously performed for each unit time by shifting the input sound by one frame.

The determination processing part 240 performs a process of determining whether the target sound is contained in the input sound from the graph of the result calculated by the calculation processing part 230.

The output processing part 250 performs a process of displaying the result determined by the determination processing part 240 on a screen or outputting by voice.

### (2. Operation)

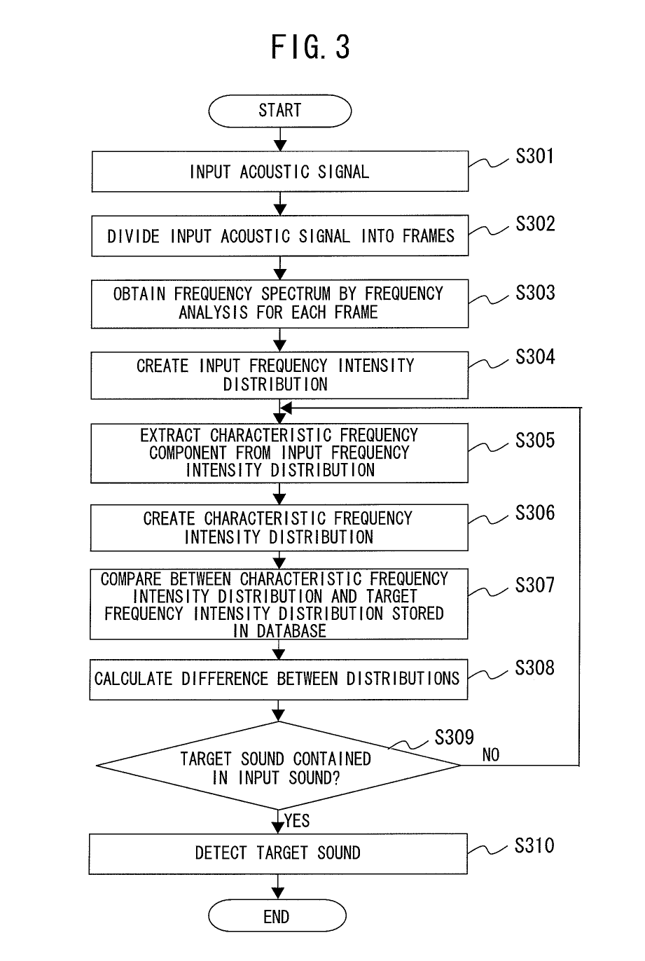

FIG. 3 is an operation chart showing the operation of the acoustic recognition apparatus 100 in accordance with the first embodiment.

First, an acoustic signal is entered from a microphone 280 (Operation S301). The acoustic signal analysis processing part 210 divides the entered acoustic signal into frames separated by a unit time (Operation S302). A frequency analysis is performed for each divided frame to obtain a frequency spectrum (Operation S303).

It should be noted that FFT(Fast Fourier transform) or wavelet transform can be used to obtain the frequency spectrum. Alternatively, the logarithm of the spectrum obtained by the transform may be used as the frequency spectrum.

On the basis of the frequency spectrum for each frame obtained by the Operation S303, an input frequency intensity distribution composed of a plurality of frames is created (Operation S304).

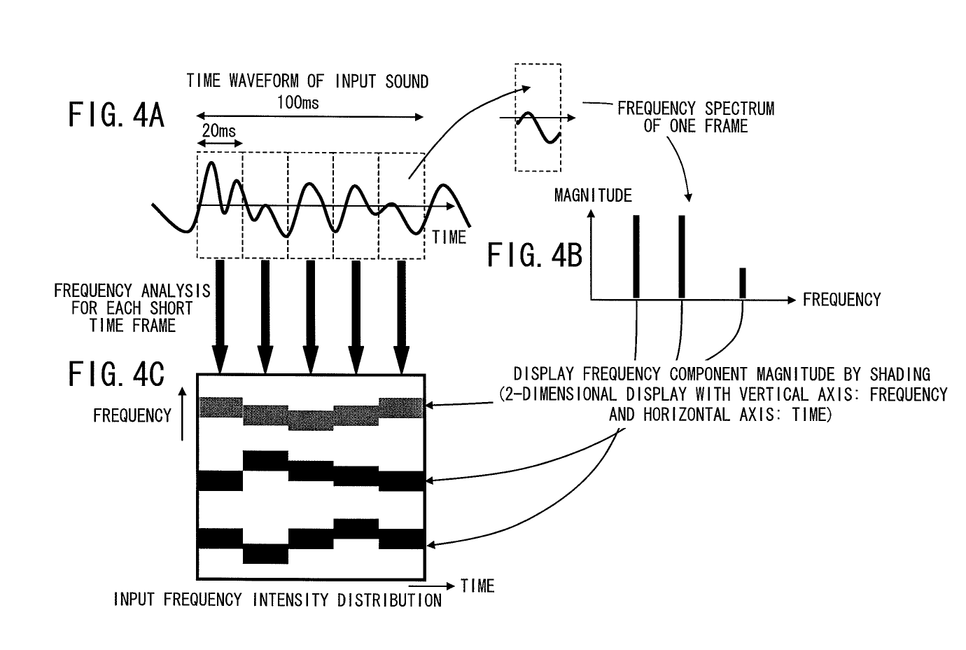

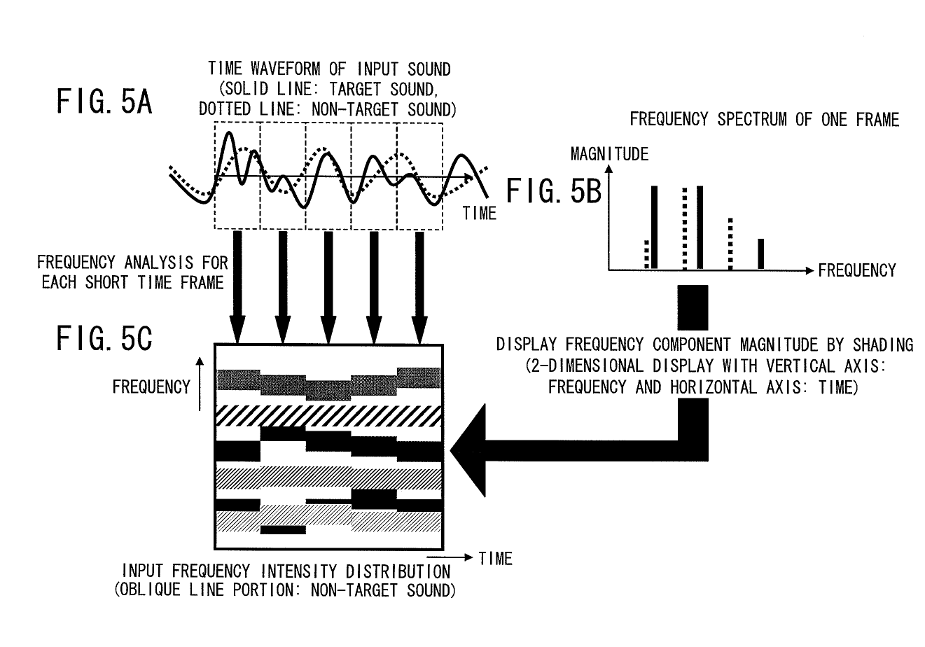

Here, the above process will be described in detail. FIGS. 4 and 5 show a process of creating an input frequency intensity distribution. FIG. 4 shows a case where the input sound contains only target sounds and FIG. 5 shows a case where a target sound and a non-target sound are mixed in the input sound.

In FIG. 4A, a wave curved line indicates a waveform of the input sound. Here, the length of one frame is set to 20 msec, and five frames (100 msec) are to be detected. Then, Fourier transform is performed for each frame to obtain a frequency spectrum shown in FIG. 4B. In FIG. 4B, the horizontal line indicates the frequency and the vertical line indicates the magnitude of its component. In other words, FIG. 4B shows an analyzed state indicating which frequency component has what intensity. On the basis of the frequency spectrum, an input frequency intensity distribution shown in FIG. 4C is created. This distribution is a 2-dimensional distribution composed of a plurality of frames, with the horizontal line indicating the time and the vertical line indicating the frequency, and the intensity of the frequency component is represented by shading. Here, a dark shading indicates a strong frequency component and a light shading indicates a weak frequency component.

FIG. 5 shows a state in which a target sound and a non-target sound are mixed. Like in FIG. 4, in FIG. 5A, a wave curved line indicates a waveform of the input sound. Here, for clarity, the solid line indicates a waveform of the target sound, and the dotted line indicates a waveform of the non-target sound. However, in fact, since the waveform of the input sound is in a mixed state, the waveforms shown in FIG. 5A are not displayed as is. Then, in the same way as in FIG. 4, FFT is performed for each frame to obtain a frequency spectrum shown in FIG. 5B. Here, the solid line indicates the target sound, and the dotted line indicates the non-target sound. On the basis of the frequency spectrum, an input frequency intensity distribution shown in FIG. 5C is created. The shaded portion indicates the frequency intensity distribution of a non-target sound. Since a non-target sound is mixed, it is understood that various kinds of frequency components are contained as compared to FIG. 4.

Now, go back to FIG. 3. The Operation S305 and after is a process of detecting a presence or absence of a target sound in the input sound.

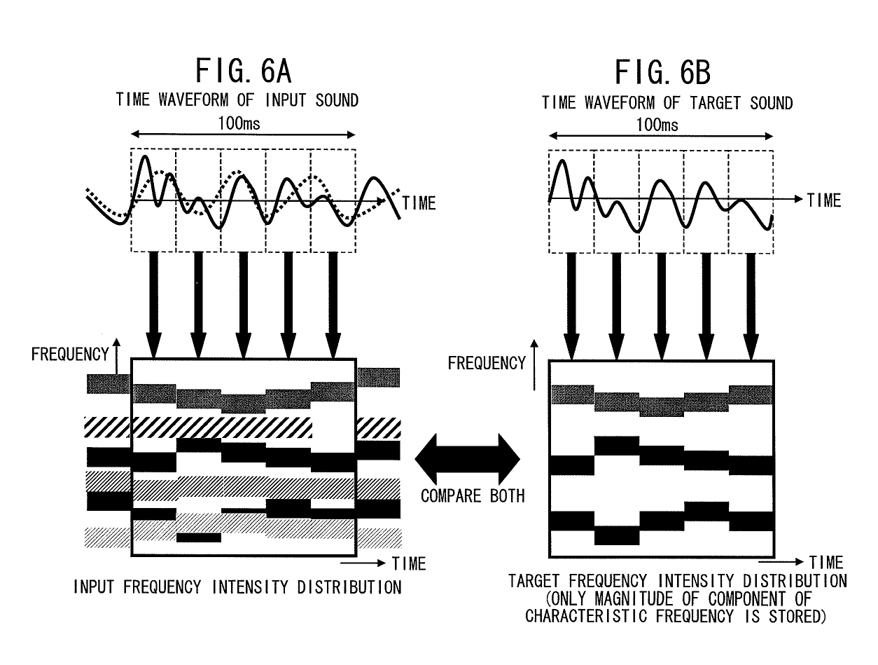

Here, the process of detecting a presence or absence of a target sound will be described. FIG. 6 shows a process of detecting a presence or absence of a target sound in the input sound. The present embodiment focuses on a fact that any acoustic source tends to be localized when the frequency distribution is observed. More specifically, if a plurality of acoustic sources are mixed, when the frequency distribution is observed, it is understood that even if multiple sounds are overlapped on the time axis, the frequency components of each sound is different, or even if the frequency components of multiple sounds are overlapped,the starting time or ending time of each sound are different. With that in mind, the target sound is analyzed in advance and is stored as the target frequency intensity distribution in the target sound storage part 260. The data is shown in FIG. 6B. With the aforementioned method, the calculation processing part performs a process of comparing the input frequency intensity distribution (FIG. 6A) of the obtained input sound. The process of comparing the target frequency intensity distribution with the input frequency intensity distribution is continuously performed at a timing for each unit time by shifting one frame.

Now, return to FIG. 3. The characteristic frequency extraction processing part 220 extracts the component of the characteristic frequency of the target sound from the input frequency intensity distribution (Operation S305), and creates a characteristic frequency intensity distribution based on the extracted result (Operation S306). The calculation processing part compares the created characteristic frequency intensity distribution with the target frequency intensity distribution stored in the target sound storage part 260 (Operation S307) and calculates the difference between the distributions (Operation S308). On the basis of the result, the determination processing part determines whether the target sound is contained in the input sound (Operation S309). If the target sound is contained in the input sound, the determination processing part informs that the target sound is detected (Operation S310) and terminates the process. If the target sound is not contained in the input sound, the process is returned to the Operation S305 in which the process starts at a timing with one frame shifted and proceeds until the above determination. The process is repeated until the target sound is detected.

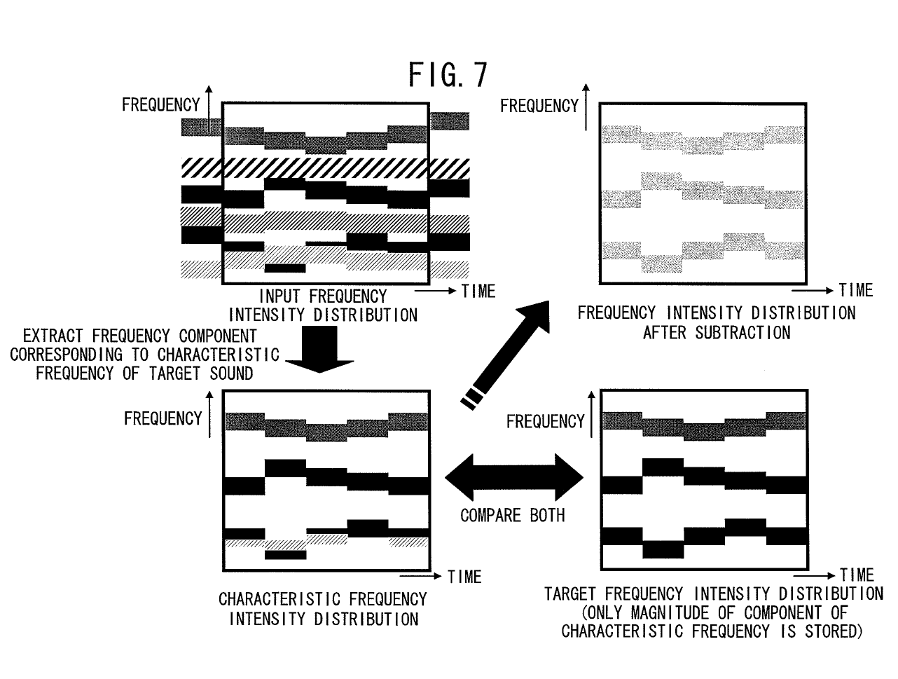

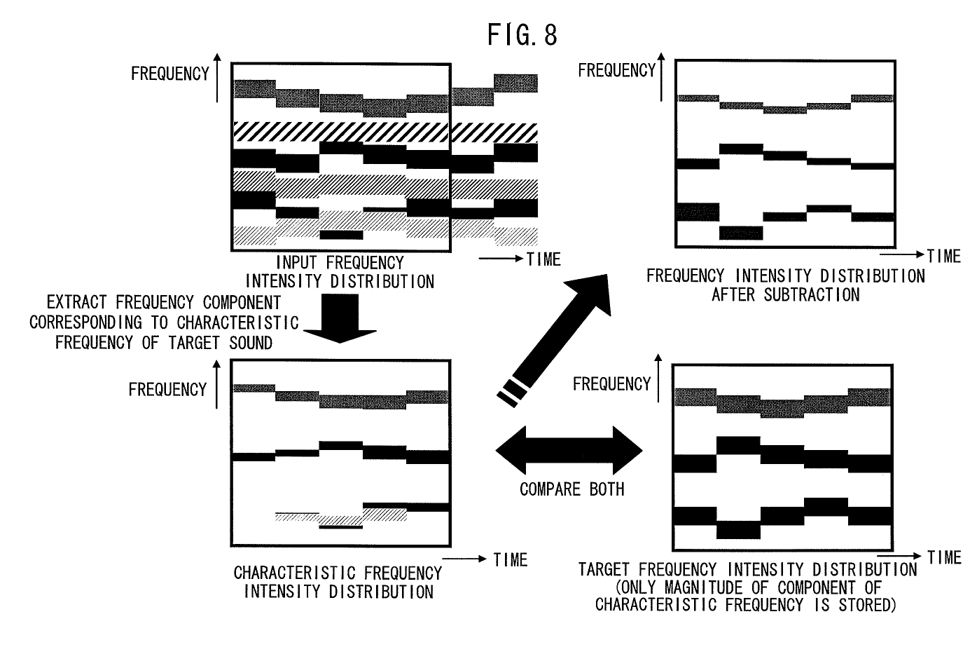

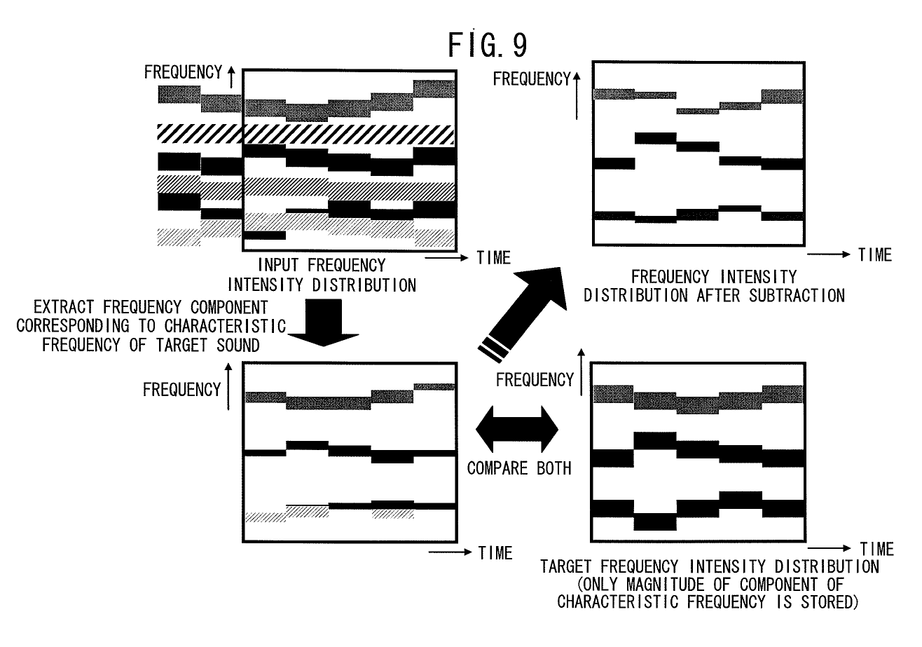

Here, the above process will be described in detail. Each of FIGS. 7, 8, and 9 shows a process of comparing between the characteristic frequency intensity distribution and the target frequency intensity distribution. FIG. 7 shows a case where the target sound is just contained in the characteristic frequency intensity distribution. FIG. 8 shows a case one frame before that of FIG. 7. FIG. 9 shows a case one frame after that of FIG. 7.

In FIG. 7, first, the characteristic frequency extraction processing part extracts only the characteristic frequency component of the target sound subject to detection from the input frequency intensity distribution. More specifically, only the frequency components before and after the characteristic frequency of the target sound are left as is and the rest are deleted for each frame. For example, assuming that the “m th” characteristic frequency of the “t” frame of the target sound is “cf(t, m)”, and the input frequency intensity distribution of the input sound is “Pin (t, f)” (t: time, f: frequency), only the characteristic frequency components of the target sound are extracted by the following expression.

$$Pin ( t , f ) = \{ \begin{matrix}Pin ( t , f ) & cf ( t , m ) - a ≦ f ≦ cf ( t , m ) + b \\ 0 & else\end{matrix} \qquad [ Formula 1 ]$$

where “a” and “b” are positive constant coefficients.

As a result of extraction, a characteristic frequency intensity distribution is created. When the characteristic frequency is extracted, most of the components of the non-target sound are deleted, but the components of the target sound are secured. In FIGS. 8 and 9, since the target sound is contained in a somewhat shifted state, the components of the target sound are also in a somewhat deleted state by the extraction process.

Then, the calculation processing part performs a process of calculating the difference by comparing between the created characteristic frequency intensity distribution and the target frequency intensity distribution. More specifically, the calculation processing part subtracts the characteristic frequency intensity distribution from the target frequency intensity distribution and determines the total value of the remaining components as the difference. Assuming that the target frequency intensity distribution is “Ptarget(t, f)” and the result of subtracting the characteristic frequency intensity distribution from the target frequency intensity distribution is “Psub(t, f)”, the following expression is obtained.

$$Psub ( t , f ) = \{ \begin{matrix}Ptarget ( t , f ) - Pin ( t , f ) & Ptarget ( t , f ) > Pin ( t , f ) \\ 0 & Ptarget ( t , f ) ≦ Pin ( t , f )\end{matrix} \qquad [ Formula 2 ]$$

The above formula assumes that if the magnitude of the frequency component corresponding to the target sound in the input sound is greater than the target sound stored in the target sound storage part 260, the subtracted result will not be negative. FIG. 7 shows a case where the target sound is just about contained in the characteristic frequency intensity distribution. In this case, the frequency distribution after subtraction is very light, and the frequency component is small. FIG. 8 shows a case of one frame (20 msec) before that of FIG. 7. In this case, there is relatively little overlapping between the characteristic frequency intensity distribution and the target frequency intensity distribution, and relatively large frequency components remain in the frequency distribution after subtraction. FIG. 9 shows a case of one frame (20 msec) after that of FIG. 7. In this case, relatively large frequency components remain in the frequency distribution after subtraction.

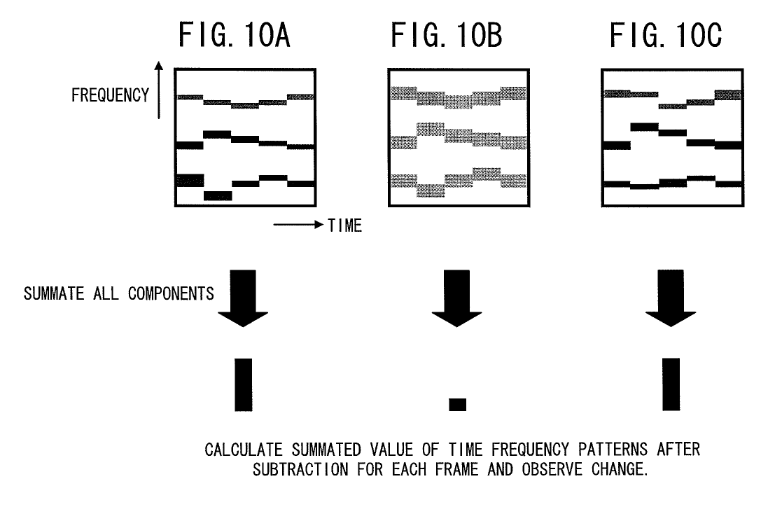

FIG. 10 shows a process of calculating the difference between the characteristic frequency intensity distribution and the target frequency intensity distribution. FIG. 10A corresponds to FIG. 8, FIG. 10B corresponds to FIG. 7, and FIG. 10C corresponds to FIG. 9. The calculation processing part performs a process of subtracting the target frequency intensity distribution from the characteristic frequency intensity distribution each at a timing with one frame shifted, and then calculating the total value of the remaining frequency components. Assuming that the total value of the frequency components after subtraction is “Powsub”, the “Powsub” at a time “t” can be expressed by the following expression.

$$Powsub ( t ) = {\sum }_{Shift = 0}^{T - 1} {\sum }_{f = f 1}^{f 2} Pub ( t \text{-} shift , f ) \\ ( but at the time of Ptarget ( t , f ) > Th ) \qquad [ Formula 3 ]$$

Where “T” indicates the length of a time period subject to analysis, “shift” indicates the time delay (number of frames). More specifically, the total value of the frequency components after subtraction at time “t” is a sum of “Psub (t, f)” of the past “T” frames including a frame at the time. Here, it is preferable to set the target time period to a few seconds. For example, assuming that one frame is 20 msec, if the target time period is set to two seconds, T=100 (frames). It should be noted that “f1” and “f2” indicate the start and the end of a frequency period subject to detection respectively. This depends on the target sound subject to detection, but in general, it is desirable to set to a range from 100 Hz to 8000 Hz.

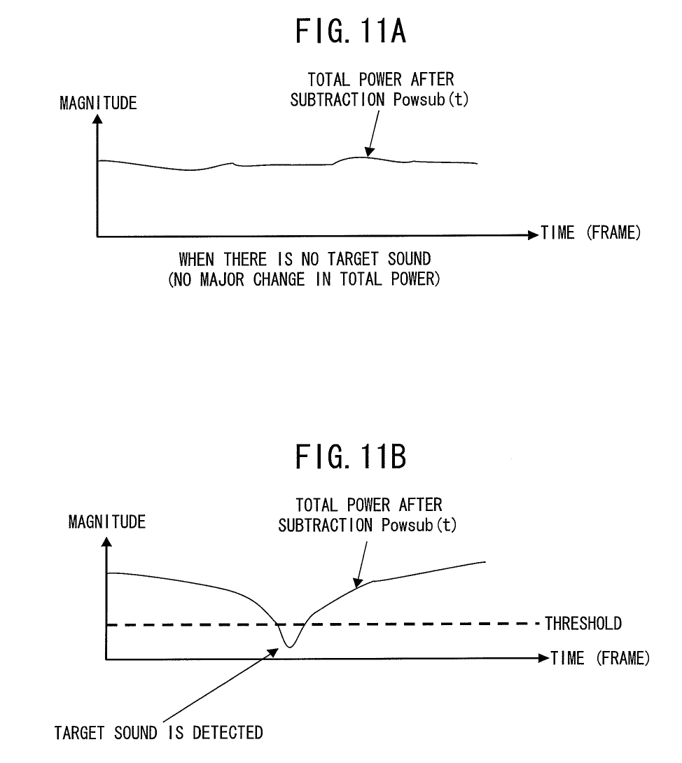

FIG. 11 shows a result of continuously plotting the total values calculated in FIG. 10. FIG. 11 shows a temporal variation of the difference between the target frequency intensity distribution and the characteristic frequency intensity distribution. FIG. 11A shows a case where there is no target sound, and FIG. 11B shows a case where there is a target sound. When there is no target sound, no major change is observed in the difference between the target frequency intensity distribution and the characteristic frequency intensity distribution. On the contrary, when there is a target sound, since a phenomenon shown in FIG. 7 occurs, the total value of the frequency component after subtraction is suddenly dropped at the time the target sound is found. At this time, it is possible to determine whether the target sound is contained in the input sound by comparing with the threshold.

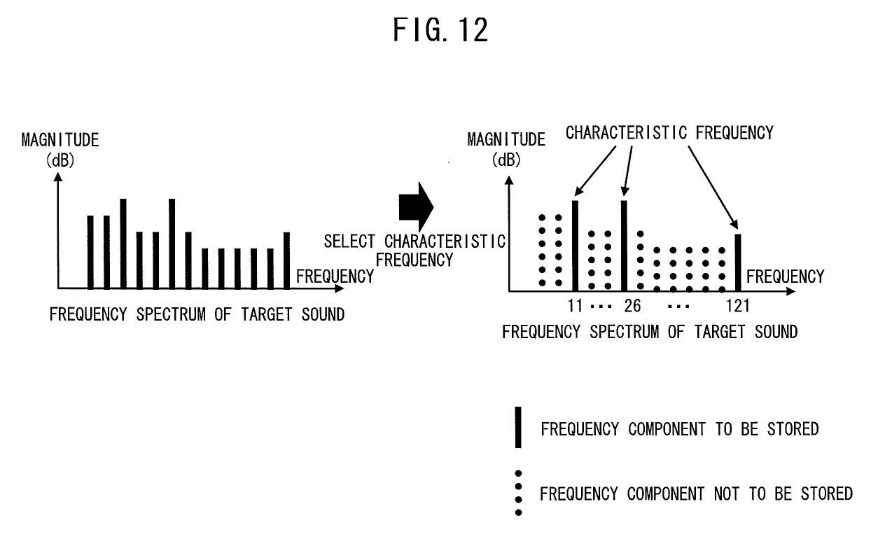

Meanwhile, information about the target sound subject to detection is previously stored in the target sound storage part 260. However, all frequencies for the target sound are not necessarily stored, but information about a sufficient number of frequency components to represent the features of the target sound may be stored. For example, FIG. 12 shows the frequency spectrum focusing on a frame containing the target sound. Here, when a frequency analysis is performed using 512-point FFT, a total of 256 frequency components are obtained for each frame. If there are three characteristic frequencies as shown in FIG. 12, only the three frequencies may be stored in the target sound storage part 260. More specifically, with reference to the frame shown in FIG. 12, only the 11th, 26th, and 121st spectrums counting from the low frequency are subject to detection, and other frequencies are ignored. Since the frequency to be selected is different for each frame, the magnitude of the frequency or the frequency component of a spectrum having the feature is stored for each frame (detailed storage method will be described later in the fourth embodiment).

Alternatively, according to the above method, the total value of the frequency components after subtraction is calculated as the difference between the target frequency intensity distribution and the characteristic frequency intensity distribution, but other methods may be used. For example, in addition to the total value of the frequency components, the area of a frequency region shown in FIG. 7 may be considered to calculate the difference.

### Second Embodiment

### (1. Configuration)

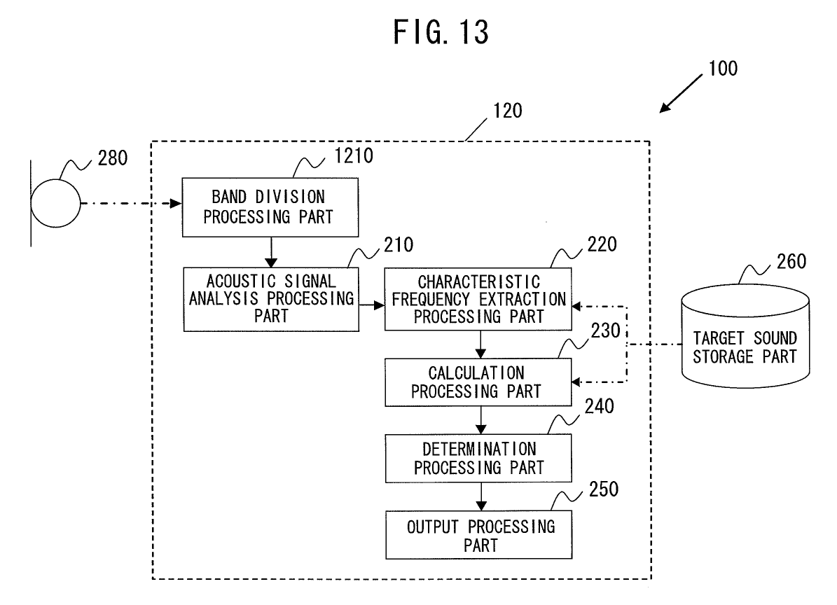

FIG. 13 is a block diagram of a module configuration of an acoustic recognition apparatus in accordance with a second embodiment. The second embodiment is different from the first embodiment in that the second embodiment is provided with a band division processing part 1210.

The band division processing part 1210 is a processing part including such that only a specific frequency band of the input sound is subject to detection and the other frequency bands are not subject to detection. The processing speed can be increased and the processing efficiency can also be enhanced by decreasing the number of detections.

### (2. Operation)

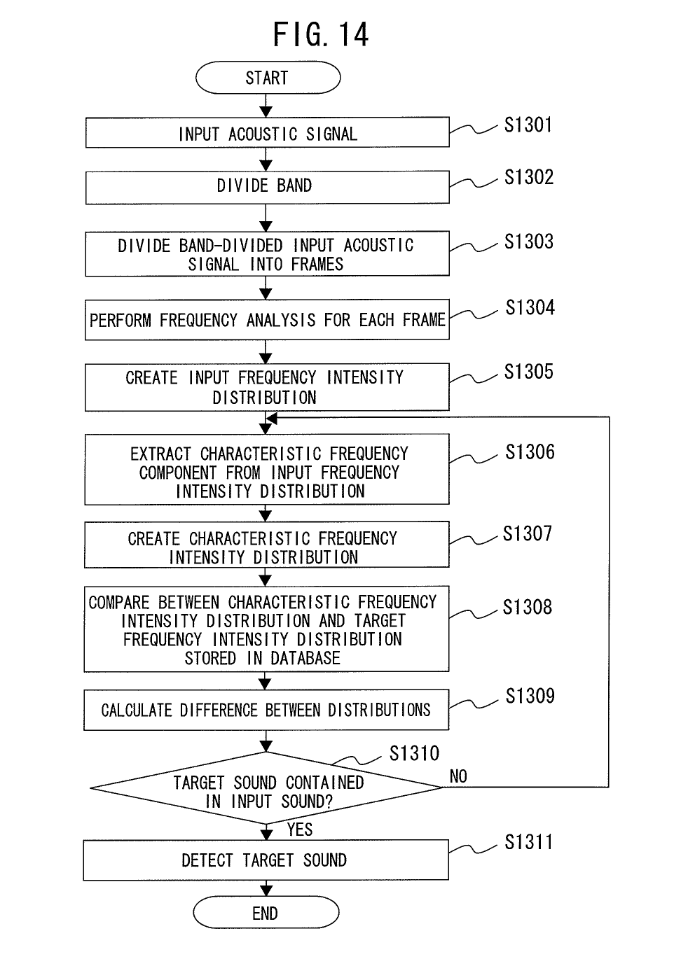

FIG. 14 is an operation chart showing the operation of the acoustic recognition apparatus 100 in accordance with the second embodiment.

First, a sound is entered from the microphone 280 and is converted into an acoustic signal (Operation S1301). The band division processing part 1210 extracts only the frequency band subject to detection from the acoustic signal and the other frequency regions are deleted (Operation S1302).

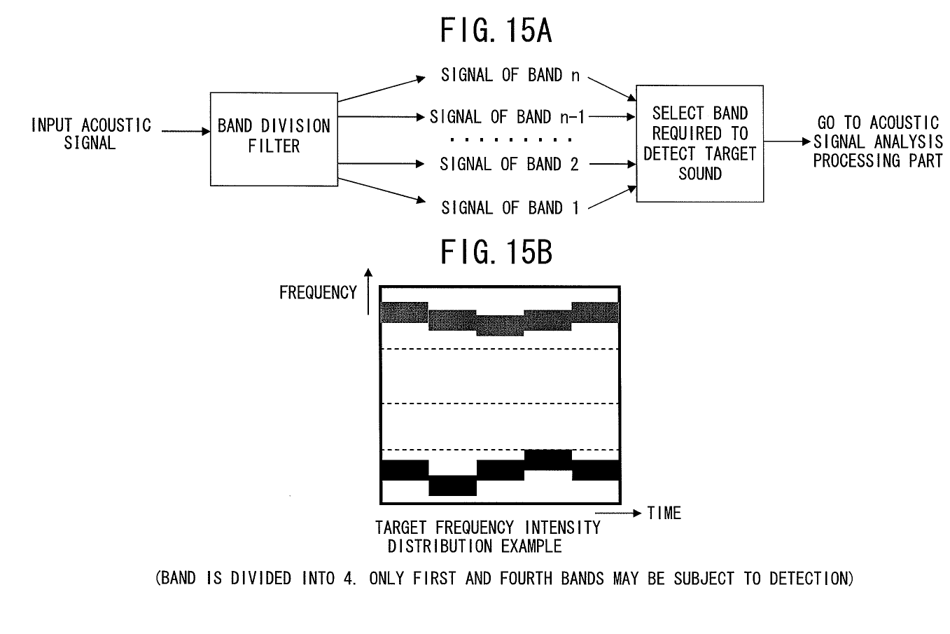

Here, the process of the band division processing part 1210 will be described in detail. FIG. 15 shows a process of dividing an input sound into predetermined frequency bands. There may be a case where only a specific frequency band can be subject to detection depending on a type of the target sound subject to detection. In that case, as shown in FIG. 15A, an input acoustic signal is passed through the band division filter, and the input sound is divided into bands. Then, only bands required to determine a presence or absence of the target sound is selected. In doing so, the amount of processing can be reduced.

FIG. 15B shows a case where a band division process is performed to determine the presence or absence of the target sound. The target sound has characteristic frequency components of a low frequency band and a high frequency region. Therefore, the frequency band is divided into four bands. Only the lowest frequency band and the highest frequency region are subject to detection and the frequency components of the second and the third frequency band are deleted.

It should be noted that a general FIR filter or QMF (Quadrature Mirror Filter) may be used as the frequency band division filter.

Now, go back to FIG. 14. After the band division process is performed, the acoustic signal analysis processing part 210 divides the band-divided input acoustic signal into frames separated by a unit time (Operation S1303) and performs frequency analysis for each of the separated frames (Operation S1304). Thereafter, processes from the Operation S1305 to the Operation S1311 in FIG. 14 are the same as those in the FIG. 3 in the first embodiment.

### Third Embodiment

### (1. Configuration)

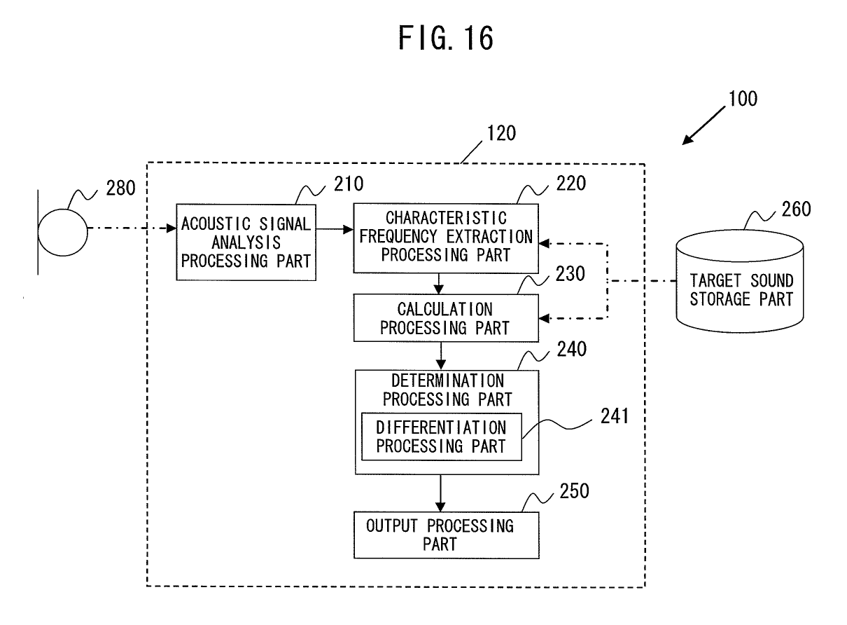

FIG. 16 is a block diagram of a module configuration of an acoustic recognition apparatus in accordance with a third embodiment. The third embodiment is different from the first embodiment in that the determination processing part 240 is provided with a differentiation processing part 241.

The differentiation processing part 241 differentiates the result which the calculation processing part 230 calculated as the difference between the target frequency intensity distribution and the characteristic frequency intensity distribution. The first-order differential maybe used for differentiation, but the second-order differential can enhance the determination accuracy.

### (2. Operation)

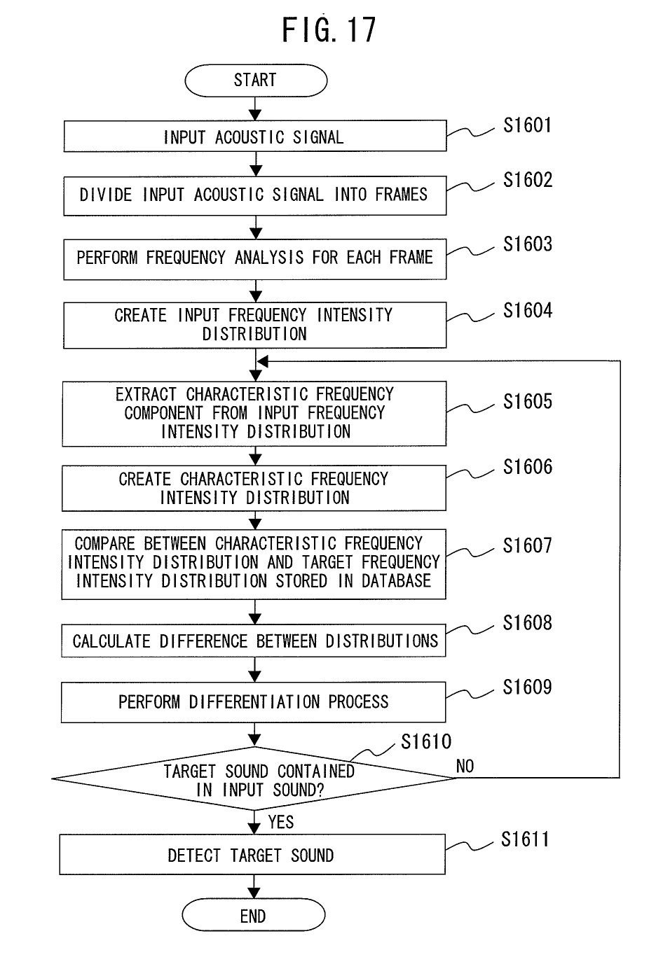

FIG. 17 is an operation chart showing the operation of the acoustic recognition apparatus 100 in accordance with the third embodiment.

The processes from the Operation S1601 to the Operation S1608 are the same as those in the first embodiment. When a graph as shown in FIG. 11 is plotted in the Operation S1608, the differentiation processing part 241 in the determination processing part 240 performs a differentiation process (Operation S1609).

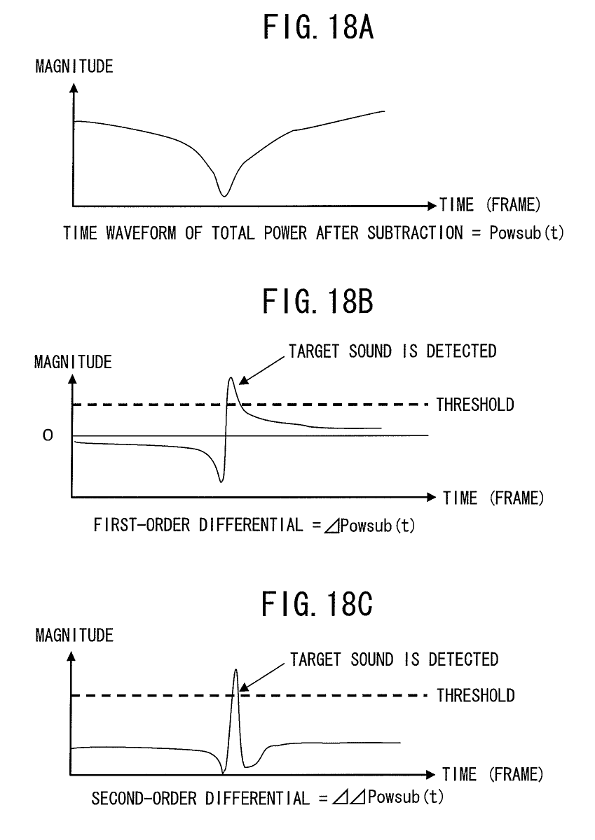

Here, the process of the differentiation processing part 241 will be described in detail. FIGS. 18A, 18B and 18C show a detection method for a case where the differentiation process is performed on a result calculated by the calculation part 230. FIG. 18A shows a waveform of “Powsub(t)” indicating the result which the calculation processing part 230 calculated as the difference between the target frequency intensity distribution and the characteristic frequency intensity distribution (Operation S1608). Here, the differentiation of “Powsub(t)” is performed by the following expression.

ΔPowsub(t)=Powsub(t)−Powsub(t−1) [Formula 4]

FIG. 18B shows a waveform of a first-order differential ΔPowsub(t) obtained by the above expression (Operation S1609) The value is greatly changed before and after the time when there is a target sound. The existence of the target sound can be detected by capturing the change of the value. For example, the change can be captured by comparing the height of the positive peak and the threshold or detecting the sign inversion. In addition, a second-order differential “ΔΔPowsub(t)” of a first-order differential “ΔPowsub(t)” can be obtained by performing differentiation on “ΔPowsub(t)”. The expression is as follows.

ΔΔPowsub(t)=ΔPowsub(t)−ΔPowsub(t−1) [Formula 5]

FIG. 18C shows a waveform of “ΔΔPowsub(t)” obtained by the above expression. A sharp peak appears by performing a second-order differentiation in the FIG. 18C (Operation S1609). The sharp peak is compared with the threshold (Operation S1610). As a result of the comparison, when the sharp peak is no higher than the threshold, go to S1605 (Operation S1610:NO). As a result of the comparison, when the sharp peak is higher than the threshold (Operation S1610:YES), the target sound can be detected with high accuracy (Operation S1611).

### Fourth Embodiment

### (1. Configuration)

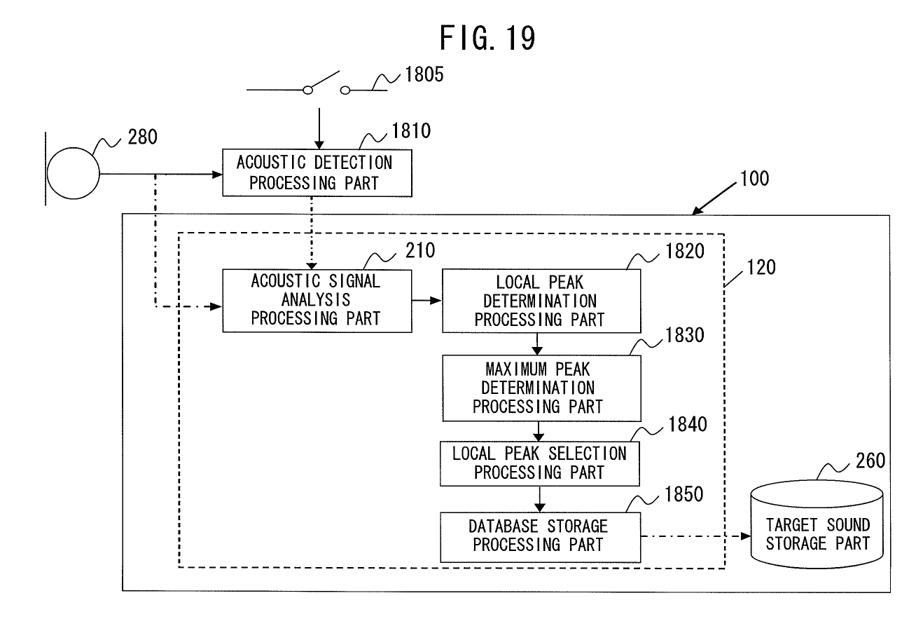

FIG. 19 is a block diagram of a module configuration of an acoustic recognition apparatus in accordance with a fourth embodiment.

The acoustic recognition apparatus 100 is provided with an acoustic detection processing part 1810, an acoustic signal analysis processing part 210, a local peak determination processing part 1820, a maximum peak determination processing part 1830, a local peak selection processing part 1840, a database storage processing part 1850, and a target sound storage part 260. According to the fourth embodiment, the user of the acoustic recognition apparatus 100 can arbitrarily store the target sound subject to detection depending on the environment in the target sound storage part 260 and the user can also create the target sound storage part 260.

The acoustic detection processing part 1810 performs a process of detecting a rising edge of a sound. When the user turns on a storage switch 1805 and a target sound to be stored makes a sound, an acoustic storage process starts and detects a rising edge of the entered acoustic signal. There are various methods of detecting a rising edge of a sound. For example, it is possible to measure the magnitude of an input acoustic signal for each unit time and compare between the magnitude thereof and the threshold.

The acoustic signal analysis processing part 210 performs the same process as in the first embodiment. It should be noted that in accordance with the fourth embodiment, processes are performed up to the process of obtaining the frequency spectrum but not the process of creating the distribution.

The local peak determination processing part 1820 determines a local peak from the frequency spectrum obtained by the acoustic signal analysis processing part 210. Search is sequentially performed to find a frequency in the frequency spectrum starting with a frequency having a low frequency component. The frequency having a frequency component larger than that of an adjacent frequency is determined as a local peak (the detail will be described later).

The maximum peak determination processing part 1830 determines the largest frequency component of all the frequency components in the frequency spectrum as a maximum peak. The process may be configured such that a maximum value is obtained from all the frequency components in the frequency spectrum or the largest peak of all the local peaks determined by the local peak determination processing part 1820 can be determined as a maximum peak.

The local peak selection processing part 1840 selects a characteristic frequency stored as the characteristic frequency of the target sound in the target sound storage part 260. Here, a local peak whose difference to the largest peak of all the local peaks is within a predetermined first threshold and whose magnitude is equal to or greater than a predetermined second threshold is selected as a characteristic frequency.

The database storage processing part 1850 performs a process of storing a local peak selected by the local peak selection processing part 1840 as a characteristic frequency in the target sound storage part 260.

It should be noted that the acoustic detection processing part 1810 may be configured to be included in the acoustic recognition apparatus 100.

### (2. Operation)

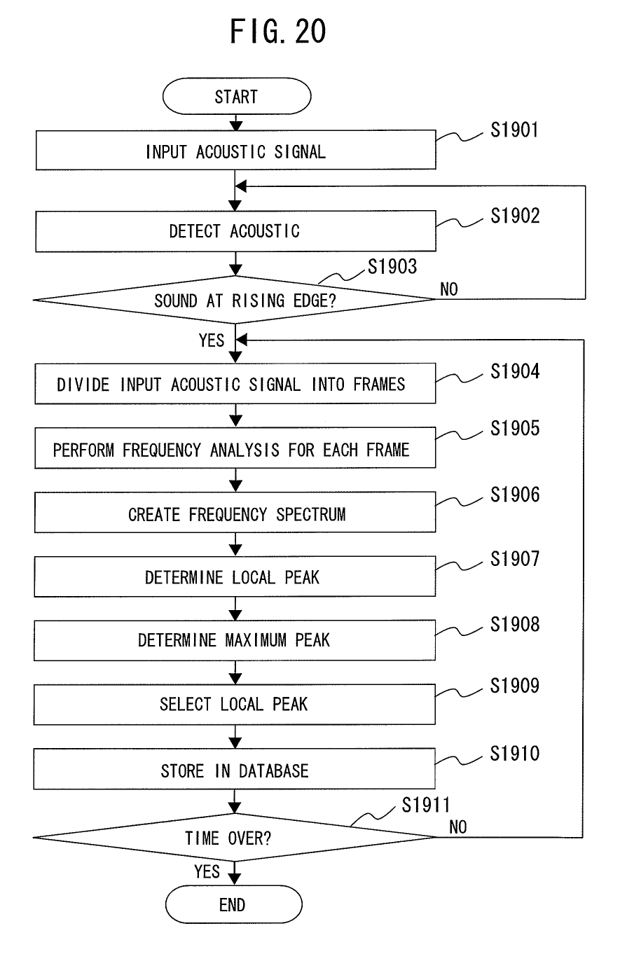

FIG. 20 is an operation chart showing the operation of the acoustic recognition apparatus 100 in accordance with the fourth embodiment.

First, an acoustic signal is entered from the microphone 280 (Operation S1901). When the user turns on the storage switch and the target sound occurs, the acoustic detection processing part 1810 detects the entered acoustic (Operation S1902). The acoustic detection processing part 1810 determines whether there is a rising edge of a sound (Operation S1903). If the rising edge of a sound cannot be detected, the process is returned to the Operation S1902 in which the acoustic detection is performed again. If the rising edge of a sound is detected, the input acoustic signal is divided into frames (Operation S1904), and then frequency analysis is performed for each frame (Operation S1905). As a result of the frequency analysis, a frequency spectrum is created (Operation S1906). On the basis of the frequency spectrum, a local peak is determined (Operation S1907).

It should be noted that here, in the same way as in the first embodiment, the frequency spectrum may be obtained by taking the logarithm of the spectrum.

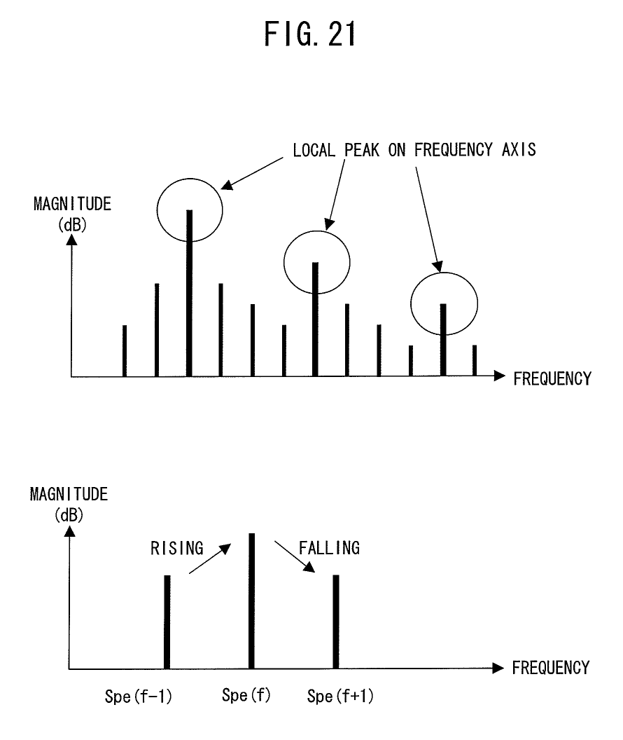

Here, the local peak determination process will be described in detail. FIG. 21 shows a process of determining a local peak. The local peak determination processing part 1820 searches the spectrum of a frame for a peak sequentially starting with a low frequency and extracts the spectrum of a frequency having a larger component than that of an adjacent frequency as a local peak. In other words, assuming that the spectrum is “Spe(f)” (f: frequency), the local peak determination processing part 1820 determines a spectrum satisfying the following expression as a local peak.

Spe(f)>Spe(f−1) and Spe(f)>Spe(f−1) [Formula 6]

Now, go back to FIG. 20. When the local peak is determined, the maximum peak determination processing part 1830 determines the maximum peak (Operation S1908). The maximum peak determination processing part 1830 determines whether a local peak of the local peaks can be regarded as a characteristic frequency of the target sound subject to detection stored in the target sound storage part 260, and then selects the peak regarded as the characteristic frequency (Operation S1909).

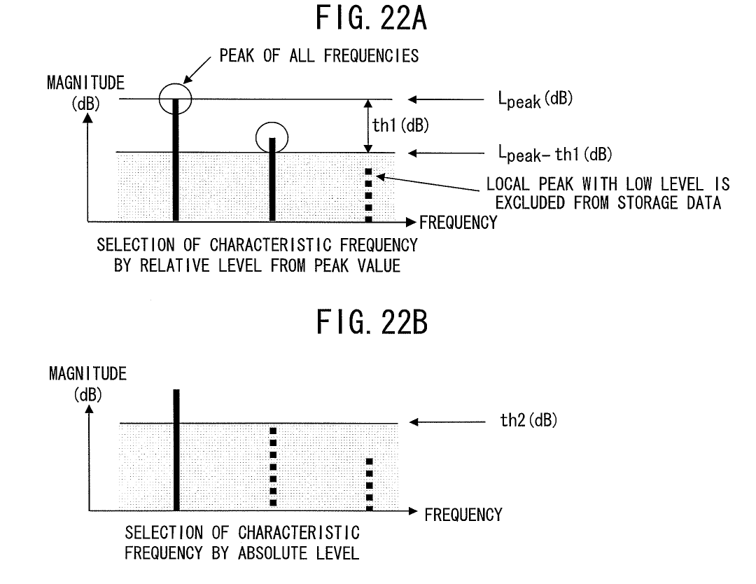

Here, the local peak selection process will be described in detail. FIG. 22 shows a process of selecting a peak which can be regarded as a characteristic frequency from the local peaks. In FIG. 22A, only the peak whose difference in magnitude of the frequency component with respect to the maximum peak is within a predetermined range is determined to be a characteristic frequency. For example, assume that if the magnitude of the maximum peak in a frame is “Lpeak (dB)”, the allowable difference is “th1”. In that case, only a local peak having a magnitude equal to or greater than “Lpeak-th1” is selected from the local peaks, and a local peak having a magnitude less than “Lpeak-th1” is not selected. Alternatively, in FIG. 22B, only the local peak having a magnitude of the frequency component equal to or greater than a predetermined value is determined as the characteristic frequency. For example, a local peak having a magnitude equal to or greater than “th2 (dB)” is selected, and a local peak having a magnitude less than “th2 (dB)” is not selected. Only the local peak satisfying all the conditions is selected as the characteristic frequency.

Now, go back to FIG. 20. The selected local peak is stored as the characteristic frequency in the target sound storage part 260 (Operation S1910).

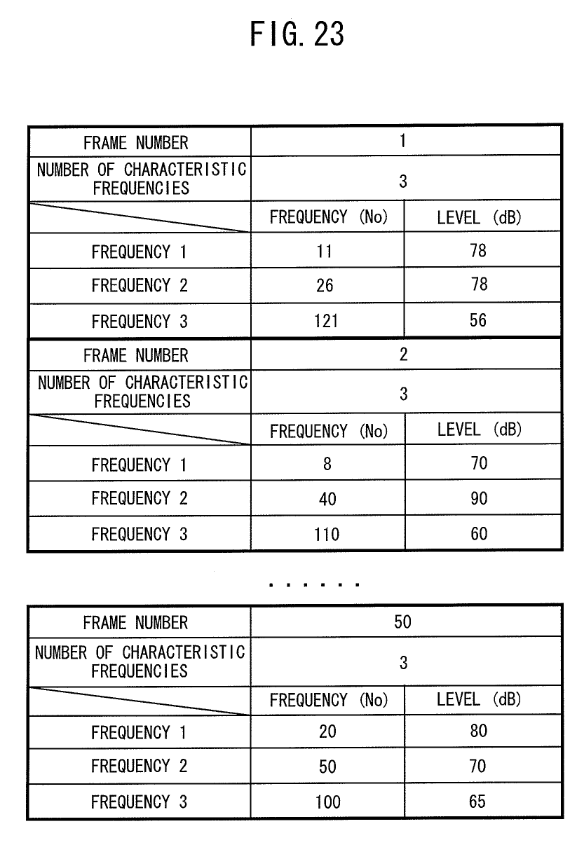

Here, the information stored in the target sound storage part 260 will be described. FIG. 23 shows an example of information stored in the target sound storage part 260. As is apparent from the figure, information about the target sound is stored for each frame. The number of characteristic frequencies, the frequency for each feature point, and the magnitude of the characteristic frequency component are stored as data for each frame in the target sound storage part 260. The target sound storage part 260 stores such data for the number of frames (e.g., 50 frames) corresponding to the specified time length in the memory. In other words, the target sound storage part 260 stores information indicating a target frequency intensity distribution.

Now, go back to FIG. 20. A determination is made to see whether a predetermined time has elapsed (Operation S1911) If the predetermined time has elapsed, the process is terminated. In other words, when a rising edge of a sound is detected, the process is repeated for each frame until a predetermined time (e.g., two seconds) has elapsed.

As described above, according to the present embodiment, only the information about the characteristic frequency having a feature of the target sound is stored in the target sound storage part 260 and the other information is not stored therein. Accordingly, it is possible to reduce the amount of use of the target sound storage part 260 as much as possible, and detect the target sound with a high accuracy.

### Fifth Embodiment

### (1. Configuration)

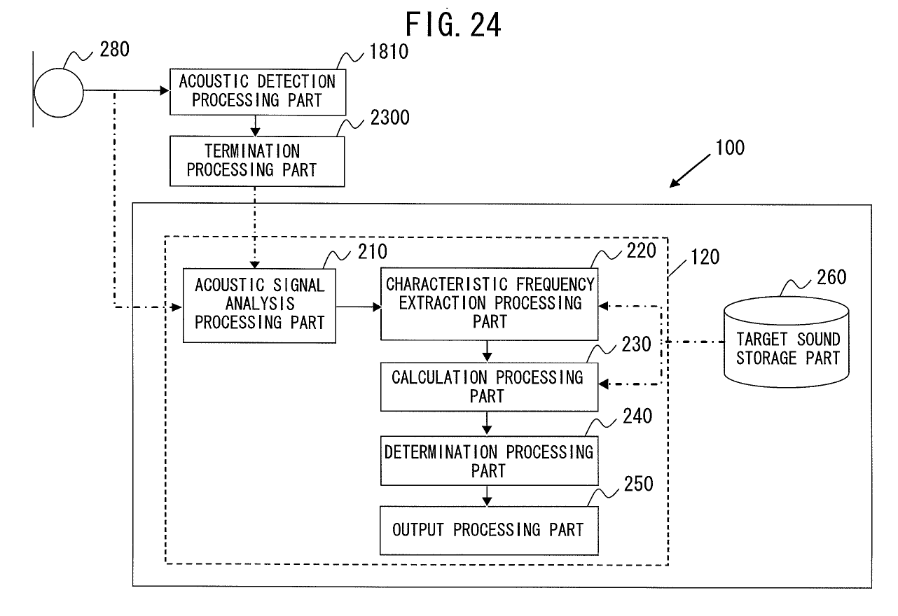

FIG. 24 is a block diagram of a module configuration of an acoustic recognition apparatus in accordance with a fifth embodiment. The fifth embodiment is different from the first embodiment in that the fifth embodiment is provided with an acoustic detection processing part 1810 and a termination processing part 2300.

The acoustic detection processing part 1810 performs a process of detecting a rising edge of a sound in the same way as in the fourth embodiment.

The termination processing part 2300 determines whether the magnitude of the acoustic detected by the acoustic detection processing part 1810 is greater than a predetermined threshold and, if the magnitude of the acoustic is less than the predetermined threshold, terminates the following process.

It should be noted that the acoustic detection processing part 1810 and the termination processing part 2300 may be configured to be included in the acoustic recognition apparatus 100.

### (2. Operation)

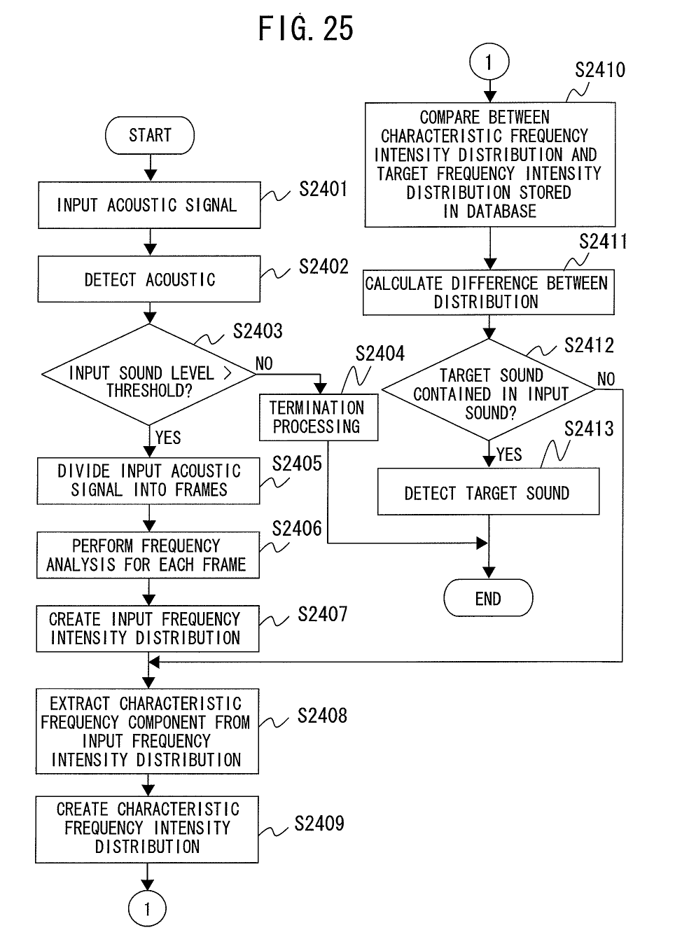

FIG. 25 is an operation chart showing the operation of the acoustic recognition apparatus 100 in accordance with the fifth embodiment.

First, a sound is entered from the microphone 280 and is converted into an acoustic signal (Operation S2401). The acoustic detection processing part 1810 detects the converted acoustic signal (Operation S2402). Comparison is made between the level of the acoustic signal and the predetermined threshold (Operation S2403). If the level of the acoustic signal is less than the predetermined threshold, the termination processing is performed to terminate the process (Operation S2404). If the level of the input sound is equal to or greater than the predetermined threshold, Operations from S2405 to S2413 are the same process as Operation from S302 to S310 in the first embodiment is performed to determine a presence or absence of the target sound.

In doing so, if it is apparent that the target sound cannot be detected, the process can be omitted in advance, thereby increasing efficiency as well as reducing power consumption.

It should be noted that an arbitrary value can be set to the predetermined threshold. If a value is set to the second threshold “th2” in accordance with the fourth embodiment, the characteristic frequency having “th2” or less will not be stored in the target sound storage part 260. Accordingly, an undetectable input sound can surely be ignored, thereby increasing the efficiency of processing.

### Other Embodiment

### (1. Configuration)

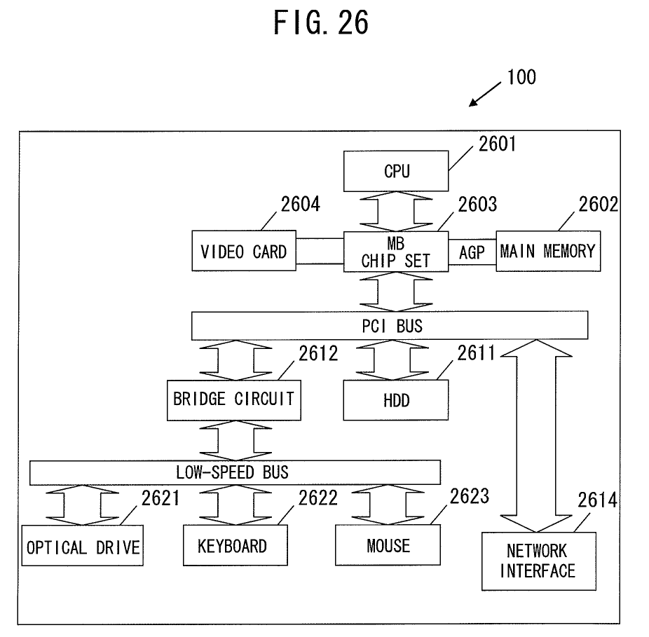

FIG. 26 is a schematic block diagram of a hardware configuration in which an acoustic recognition apparatus 100 in accordance with these embodiments is implemented as a personal computer.

The acoustic recognition apparatus 100 in accordance with the present embodiment is provided with a CPU (Central Processing Unit) 2601, a main memory 2602, a mother board chip set 2603, a video card 2604, an HDD (Hard Disk Drive) 2611, abridge circuit 2612, an optical drive 2621, a keyboard 2622, and a mouse 2623.

The main memory 2602 is connected to the CPU 2601 through a CPU bus and the mother board chip set 2603. The video card 2604 is connected to the CPU 2601 through an AGB (Accelerated Graphics Port) and the mother board chip set 2603. The HDD 2611 is connected to the CPU 2601 through a PCI (Peripheral Component Interconnect) bus and the mother board chip set 2603.

The optical drive 2621 is connected to the CPU 2601 through a low-speed bus, the bridge circuit 2612 between the low-speed bus and the PCI bus, the PCI bus, and the mother board chip set 2603. The key board 2622 and the mouse 2623 are connected to the CPU 2601 through the same connection configuration. The optical drive 2621 reads (or reads and writes) data by emitting a laser beam onto an optical disk. The examples of the optical drive include a CD-ROM drive and a DVD drive.

The acoustic recognition apparatus 100 can be built by both copying an acoustic recognition program into the HDD 2611 and performing so called installation which is configured so that the acoustic recognition program copied in the main memory 2602 can be loaded (this installation is just an example). When the user instructs the OS (Operating System) which controls the computer to activate the acoustic recognition apparatus 100, the acoustic recognition program is loaded into the main memory 2602 and is activated.

It should be noted that the acoustic recognition program may be configured to be provided from a recording medium such as a CD-ROM or may be configured to be provided from another computer connected to a network through the network interface 2614.

As described above, even a hardware configuration in which the acoustic recognition apparatus 100 is implemented as a personal computer can also perform the process of the above specific embodiments.

The hardware configuration of FIG. 26 shows just an example and other hardware configurations may naturally be used as long as the configuration can perform the above specific embodiments.

In addition, the above specific embodiments can be applied, for example, to determine whether an abnormal sound is produced in a machine. Alternatively, the above embodiments can be used for access security for checking entrance and exit by recognizing a sound.

In the foregoing description, the present invention has been described with reference to the specific embodiments, but the scope of the present invention is not limited to the description of the embodiments and various modifications or improvements can be made to each particular embodiment. An embodiment to which those modifications or improvements are made is also included in the scope of the present invention. This is apparent from the appended claims.

What is claimed is:

1. An acoustic recognition apparatus that determines whether or not a pre-stored target acoustic signal of a target sound subject to detection is contained in an entered input acoustic signal, said acoustic recognition apparatus comprising:
an acoustic signal analysis part which divides said input acoustic signal into a plurality of frames separated by a unit time including at least one cycle of said target acoustic signal, obtains a frequency spectrum of said frames analyzed for each frequency, and creates an input frequency intensity distribution composed of the plurality of said frames based on said frequency spectrum;
a target sound storage part which divides said target acoustic signal into a plurality of frames, analyzes said target acoustic signal in said divided frames for each characteristic frequency having a feature of said target acoustic signal, and stores said characteristic frequency having a feature of said target acoustic signal as a target frequency intensity distribution;
a characteristic frequency extraction part which extracts only a component of a characteristic frequency of said target acoustic signal stored by said target sound storage part from said input frequency intensity distribution created by said acoustic signal analysis part, and creates a characteristic frequency intensity distribution;
a calculation part which continuously compares said target frequency intensity distribution stored by said target sound storage part with said characteristic frequency intensity distribution created by said characteristic frequency extraction part by shifting said frames, and calculates a difference between said target frequency intensity distribution and said characteristic frequency intensity distribution; and
a determination part which determines whether or not said target acoustic signal is contained in said input acoustic signal based on the difference calculated by said calculation part.

2. The acoustic recognition apparatus according to claim 1, further comprising:
a band division part which band-divides said input acoustic signal.

3. The acoustic recognition apparatus according to claim 1, wherein
said determination part further includes a differentiation part for differentiating the difference calculated by said calculation part.

4. The acoustic recognition apparatus according to claim 2, wherein
said determination part further includes a differentiation part for differentiating the difference calculated by said calculation part.

5. The acoustic recognition apparatus according to claim 1, further comprising:
a local peak determination part which compares an arbitrary frequency component with a frequency component adjacent to the arbitrary frequency component in said frequency spectrum for each of said frames obtained by said acoustic signal analysis part, and if said arbitrary frequency component is larger than said adjacent frequency component, determines said arbitrary frequency component as a local peak;
a maximum peak determination part which determines a frequency component having the largest magnitude of all the frequency components in said frequency spectrum as a maximum peak;
a local peak selection part which selects a local peak whose difference in magnitude of the frequency component with respect to said maximum peak is within a predetermined first threshold and the magnitude of the frequency component of said local peak is equal to or greater than a predetermined second threshold, from the frequency components of local peaks determined by said local peak determination part; and
a database storage part which stores a local peak selected by said local peak selection part as a characteristic frequency component of said target sound in a database.

6. The acoustic recognition apparatus according to claim 2, further comprising:
a local peak determination part which compares an arbitrary frequency component with a frequency component adjacent to said arbitrary frequency component in said frequency spectrum for each of said frames obtained by said acoustic signal analysis part, and if said arbitrary frequency component is larger than said adjacent frequency component, determines said arbitrary frequency component as a local peak;
a maximum peak determination part which determines a frequency component having the largest magnitude of all the frequency components in said frequency spectrum as a maximum peak;
a local peak selection part which selects a local peak whose difference in magnitude of the frequency component with respect to said maximum peak is within a predetermined first threshold and the magnitude of the frequency component of said local peak is equal to or greater than a predetermined second threshold, from the frequency components of local peaks determined by said local peak determination part; and
a database storage part which stores a local peak selected by said local peak selection part as a characteristic frequency component of said target sound in a database.

7. The acoustic recognition apparatus according to claim 3, further comprising:
a local peak determination part which compares an arbitrary frequency component with a frequency component adjacent to the arbitrary frequency component in said frequency spectrum for each of said frames obtained by said acoustic signal analysis part, and if said arbitrary frequency component is larger than said adjacent frequency component, determines said arbitrary frequency component as a local peak;
a maximum peak determination part which determines a frequency component having the largest magnitude of all the frequency components in said frequency spectrum as a maximum peak;
a local peak selection part which selects a local peak whose difference in magnitude of the frequency component with respect to said maximum peak is within a predetermined first threshold and the magnitude of the frequency component of said local peak is equal to or greater than a predetermined second threshold, from the frequency components of local peaks determined by said local peak determination part; and
a database storage part which stores a local peak selected by said local peak selection part as a characteristic frequency component of said target sound in a database.

8. The acoustic recognition apparatus according to claim 4, further comprising:
a local peak determination part which compares an arbitrary frequency component with a frequency component adjacent to the arbitrary frequency component in said frequency spectrum for each of said frames obtained by said acoustic signal analysis part, and if said arbitrary frequency component is larger than said adjacent frequency component, determines said arbitrary frequency component as a local peak;
a maximum peak determination part which determines a frequency component having the largest magnitude of all the frequency components in said frequency spectrum as a maximum peak;
a local peak selection part which selects a local peak whose difference in magnitude of the frequency component with respect to said maximum peak is within a predetermined first threshold and the magnitude of the frequency component of said local peak is equal to or greater than a predetermined second threshold, from the frequency components of local peaks determined by said local peak determination part; and
a database storage part which stores a local peak selected by said local peak selection part as a characteristic frequency component of said target sound in a database.

9. The acoustic recognition apparatus according to claim 1, further comprising:
a termination part which, when the magnitude of the frequency component of said input acoustic signal is equal to or less than a predetermined threshold, terminates the acoustic recognition process.

10. The acoustic recognition apparatus according to claim 2, further comprising:
a termination part which, when the magnitude of the frequency component of said input acoustic signal is equal to or less than a predetermined threshold, terminates the acoustic recognition process.

11. The acoustic recognition apparatus according to claim 3, further comprising:
a termination part which, when the magnitude of the frequency component of said input acoustic signal is equal to or less than a predetermined threshold, terminates the acoustic recognition process.

12. The acoustic recognition apparatus according to claim 4, further comprising:
a termination part which, when the magnitude of the frequency component of said input acoustic signal is equal to or less than a predetermined threshold, terminates the acoustic recognition process.

13. The acoustic recognition apparatus according to claim 5, further comprising:
a termination part which, when the magnitude of the frequency component of said input acoustic signal is equal to or less than a predetermined threshold, terminates the acoustic recognition process.

14. The acoustic recognition apparatus according to claim 6, further comprising:
a termination part which, when the magnitude of the frequency component of said input acoustic signal is equal to or less than a predetermined threshold, terminates the acoustic recognition process.

15. The acoustic recognition apparatus according to claim 7, further comprising:
a termination part which, when the magnitude of the frequency component of said input acoustic signal is equal to or less than a predetermined threshold, terminates the acoustic recognition process.

16. The acoustic recognition apparatus according to claim 8, further comprising:
a termination part which, when the magnitude of the frequency component of said input acoustic signal is equal to or less than a predetermined threshold, terminates the acoustic recognition process.

17. An acoustic recognition method of causing a computer to execute as an acoustic recognition apparatus that determines whether a pre-stored target acoustic signal of a target sound subject to detection is contained in an entered input acoustic signal or not, said acoustic recognition method comprising the operations of:
dividing said input acoustic signal into frames separated by a unit time including at least one cycle of said target acoustic signal, obtaining a frequency spectrum of said frame analyzed for each frequency, and creating an input frequency intensity distribution composed of a plurality of said frames based on said frequency spectrum;
dividing said target acoustic signal into said frames, analyzing said target acoustic signals in said divided frames for each characteristic frequency having a feature of said target acoustic signal, and storing characteristic frequency having the feature of said target acoustic signal as a target frequency intensity distribution;
extracting only a component of a characteristic frequency of the target acoustic signal from said input frequency intensity distribution, and creating a characteristic frequency intensity distribution;
continuously comparing said target frequency intensity distribution with said characteristic frequency intensity distribution by shifting said frames, and calculating a difference between said characteristic frequency intensity distribution and said characteristic frequency intensity distribution; and
determining whether said target acoustic signal is contained in said input acoustic signal based on the difference.

18. A computer-readable storage medium storing a computer program which determines whether a pre-stored target acoustic signal of a target sound subject to detection is contained in an entered input acoustic signal, said program causing a computer to perform operations comprising:
dividing said input acoustic signal into frames separated by a unit time including at least one cycle of said target acoustic signal, obtaining a frequency spectrum of said frame analyzed for each frequency, and creating an input frequency intensity distribution composed of a plurality of said frames based on said frequency spectrum;
dividing said target acoustic signal into said frames, analyzing said target acoustic signal of said divided frames for each characteristic frequency having a feature of said target acoustic signal, and storing characteristic frequency having a feature of said target acoustic signal as a target frequency intensity distribution;
extracting only a component of a characteristic frequency of the target acoustic signal from said input frequency intensity distribution, and creating a characteristic frequency intensity distribution;
continuously comparing said target frequency intensity distribution with said characteristic frequency intensity distribution by shifting said frames, and calculating the difference between said characteristic frequency intensity distribution and said characteristic frequency intensity distribution; and
determining whether said target acoustic signal is contained in said input acoustic signal based on the difference or not.
